(19) United States
(12) Patent Application Publication
(10) Pub. No.: US 2012/0227267 A1
(43) Pub. Date: Sep. 13, 2012

(54) DOUBLE-ENDED HAND KNIFE

(75) Inventor: Jianping Qiu, Hangzhou City (CN)

(73) Assignees: 2) HANGZHOU GREAT STAR TOOLS CO., LTD., Hangzhou City, Zhejiang Province (CN); HANGZHOU GREAT STAR INDUSTRIAL CO., LTD., Hangzhou City, Zhejiang Province (CN)

(21) Appl. No.: 13/393,342

(22) PCT Filed: Aug. 31, 2010
(86) PCT No.: PCT/CN2010/076505

§ 371 Date: May 16, 2012

(30) Foreign Application Priority Data
Aug. 31, 2009 (CN) 200920192138.0

(51) Int. Cl. B26B 5/00; B26B 1/08; B26B 1/04

(52) U.S. Cl. 30/152; 30/299

(57) ABSTRACT

The invention discloses a utility knife, including at least a utility knife body, which has a first end part and a second end part; the first end part is arranged with a first mounting bracket, and the second end part is arranged with a second mounting bracket. A first blade is arranged detachably on the first mounting bracket; a second blade is arranged detachably on the second mounting bracket. Users can select appropriate blades to work during operation, or alternatively use different blades to operate without replacing blades. When a blade on one end becomes non-serviceable, users can immediately switch to use the blade on the other end to continue operation, which prolongs the time of continuous work and enhances the efficiency.

### FIELD OF THE INVENTION

The invention relates to the field of manual tools, and particularly to a utility knife.

### DESCRIPTION OF THE PRIOR ART

A common utility knife structurally includes a handle for gripping, one end of which arranged with a cutting part, such as a blade, etc. The cutting part can be contained inside the handle when not in use. Such utility knives, having only one cutting part, have a rather limited and simplistic functionality, and are unable to satisfy the practical demand for its diversified usage.

Of a utility knife with replaceable blades, the blade holder is adaptable to mount blades of different functionalities. To use a blade of a different functionality, just replace the original with a blade of above functionality. Besides, if a blade is worn out, it can be replaced with a new blade of identical functionality for continual usage.

However, replacing blades is sometimes inconvenient, especially in certain working environment, such as operation at a high place like on a roof, in that usually one of the hands is reserved to hold on to some object to ensure safety, and normally two hands are needed for replacing blades, which would induce safety hazard. Moving to a safe place for blade replacement, however, would waste time. In some further situation that blades of different functionalities are used frequently for different operations, like using a trapezoidal blade (FIG. 5) for incision and using a horn-shaped blade (FIG. 6) for segmentation, frequent replacement of blades is inconvenient and trouble-some.

Thus, technicians of this field endeavor to develop a utility knife which minimizes frequency of blade replacement.

### SUMMARY OF THE INVENTION

In view of the above defects with the prior art, the present invention aims to provide a utility knife with multiple blades for simultaneous use which minimizes frequency of blade replacement.

In order to realize the above purpose, the invention provides a utility knife, including at least a utility knife body which has a first end part and a second end part, where the first end part is arranged with a first mounting bracket for holding a first blade, and the second end part is arranged with a second mounting bracket for holding a second blade.

In an embodiment, the first blade and the second blade can be identical blades, or blades of different cutting functionalities.

Further, the first mounting bracket and/or the second mounting bracket are in a first work position exposed outside of the utility knife body and in a second work position contained inside the utility knife body.

In an embodiment, the first mounting bracket and/or the second mounting bracket which are in the first work position when in unfolded state and in the seconded work position when in folded state, connect pivotally to the utility knife body by pivots. In other embodiments, the first mounting bracket and/or the second mounting bracket can extend and retract relative to the utility knife body through an extendable mechanism. At least one mounting bracket locates in the first work position when in extended state and locates in the second work position when in retracted state.

The present invention adopts the above structure, where mounting brackets are arranged respectively on the end parts of the utility knife body, and identical or different blades can be arranged detachably on mounting brackets, respectively. Users, especially those who work at high places in special environments, with limited freedom allowed to both hands, find it difficult to replace blades. While using the utility knife with blades at both ends according to the present invention, users can select an appropriate blade to work during operation, or alternatively use different blades to operate, so as to be able to work continuously without replacing blades.

If mounting brackets are mounted with blades of identical type respectively, when a blade on one end becomes non-serviceable, users can immediately switch to use the blade on the other end to resume working, which prolongs the time of continuous work and enhances the efficiency.

Referencing now to the figures, the conception, detailed structure and induced technical effect of the present invention will be expounded for due understanding of the purpose, characterizations and effects of the present invention:

### BRIEF DESCRIPTION OF THE DRAWINGS

FIG. 1 shows a structural schematic view of an embodiment in an unfolded state.

FIG. 2 is a structural bottom schematic view of the embodiment as shown in FIG. 1.

FIG. 3 is a structural vertical schematic view of the embodiment as shown in FIG. 1.

FIG. 4 is a structural schematic view of the embodiment as shown in FIG. 1 in a folded state.

FIG. 5 is a structural schematic view of the blade 21 as shown in FIG. 1.

FIG. 6 is a structural schematic view of the utility knife 22 as shown in FIG. 1.

FIG. 7 is another schematic view of FIG. 1 in use.

FIG. 8 is further schematic view of FIG. 1 in use

FIG. 9 is a structural schematic view of a second embodiment of the present invention in unfolded state.

FIG. 10 is a structural schematic view of a third embodiment of the present invention in unfolded state.

FIG. 11 is a structural vertical schematic view of the embodiment as shown in FIG. 10.

FIG. 12 is a structural schematic view of the embodiment as shown in FIG. 10 in folded state.

FIG. 13 is a structural vertical schematic view of the embodiment as shown in FIG. 10 in folded state.

### DETAILED DESCRIPTION OF THE PREFERRED EMBODIMENTS

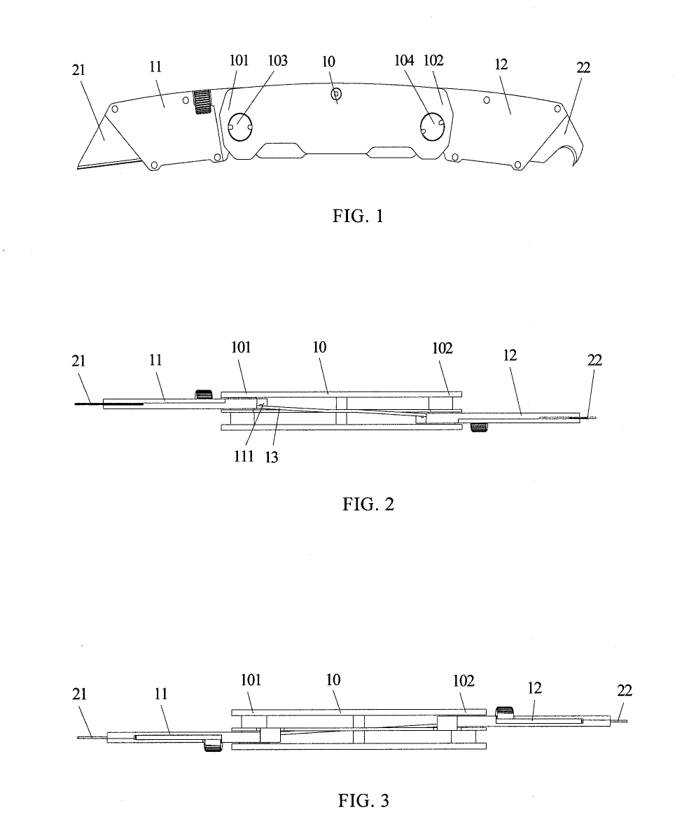

As shown in FIG. 1-2, the first embodiment of the present invention includes a utility knife body 10, which also functions as a handle part and has a first end part 101 and a second end part 102.

The first end part 101 is arranged with a first mounting bracket 11, and a blade 21 is arranged detachably on the first mounting bracket 11.

The second end part 102 is arranged with a second mounting bracket 12, and a blade 22 is arranged detachably on the second mounting bracket 12.

As shown in FIG. 1, in this embodiment, the first mounting bracket 11 is arranged pivotally on the utility knife body 10 by the pivot 103. The first mounting bracket 11 is in a first work position exposed to the outside of the utility knife body when in unfolded state.

Likewise, the second mounting bracket 12 is arranged pivotally on the utility knife body 10 by the pivot 104, which is in a first work position exposed to the outside of the utility knife body when in unfolded state.

A shown in FIG. 2-3, further, the utility knife body 10 is arranged with a retaining member 13 thereon and the first mounting bracket 11 is arranged with a retaining part 111 thereon engaging with the retaining member 13 for retaining purpose.

In this embodiment, the retaining member 13 is a resilient steel sheet. When the first mounting bracket 11 is in unfolded state, the retaining member 13 bears against the retaining part 111 and keeps the first mounting bracket 11 stably in unfolded state to ensure smooth operation and also to avoid harming the user due to operation errors.

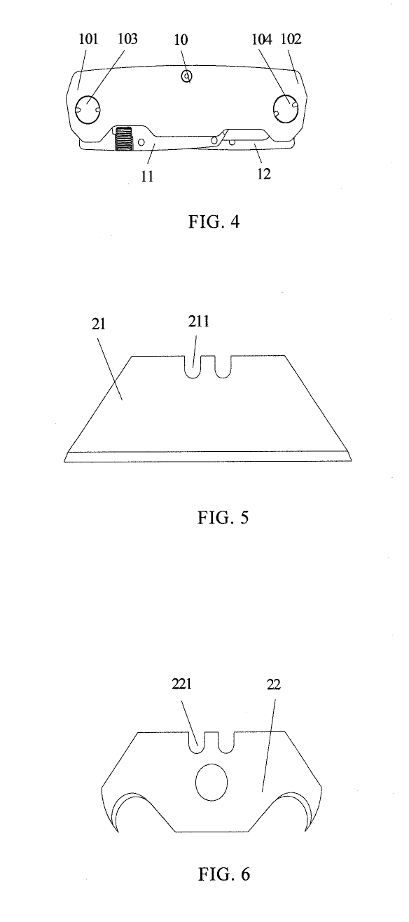

As shown in FIG. 4, the first mounting bracket 11 is in a second work position contained inside the utility knife body 10 when in folded state. Likewise, the second mounting bracket 12 is in a second work position contained inside the utility knife body 10 when in folded state.

As shown in FIG. 5, the blade 21 is a trapezoidal blade, whose thickness is between 0.3 mm and 1.0 mm Said blade 21 has on its back a clamping notch 211 arranged for snapping-fit with the first mounting bracket 11.

As shown in FIG. 6, in the above embodiment, the blade 22 is a horn-shaped blade having a different cutting functionality to a trapezoidal blade.

Further, said blade 22 has on its back a clamping notch 221 arranged for snapping-fit with the second mounting bracket 12.

By designing the clamping notch 211 and clamping notch 221 with identical sizes and structures, the blades 21, 22 can be mounted interchangeably on mounting brackets 11, 12.

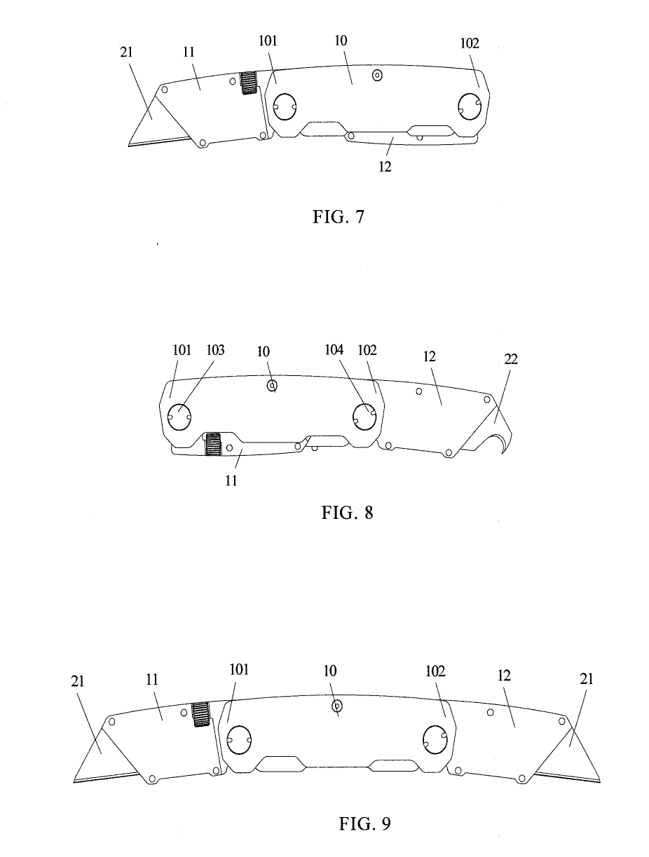

As shown in FIG. 7, during operation, users can keep the second mounting bracket 12 and the blade 22 in folded state, which is in the second work position. And the first mounting bracket 11 and the blade 21 can be rotated clockwise around the pivot 103 to switch to unfolded state, which is in the first work position for operation.

When the working part needs to be switched during operation, as shown in FIG. 8, users can rotate anti-clockwise the first mounting bracket 11 and the blade 21 around the pivot 103 to switch to folded state, which is in the second work position. And the second mounting bracket 12 and the blade 22 are rotated anti-clockwise around the pivot 104 to switch to unfolded state, which is in the first work position for operation.

The utility knife of the present invention has on both ends of its utility knife body arranged with mounting brackets 11, 12, which are used for mounting different blades 21, 22, allowing the present invention to satisfy the demands for different operations using different types of blades in practice.

FIG. 9 shows the second embodiment of the present invention, this embodiment has a basically identical structure to the first embodiment, the difference of which lies in that the second mounting bracket 12 is mounted with an identical blade with what is mounted on the first mounting bracket 11, such as the trapezoidal blade 21.

During operation, when the blade 21 on the first mounting bracket 11 becomes non-serviceable or drops down due to carelessness, users can resume working by using the other blade 21 on the second mounting bracket 12, which prolongs the time of continuous work and enhances the efficiency.

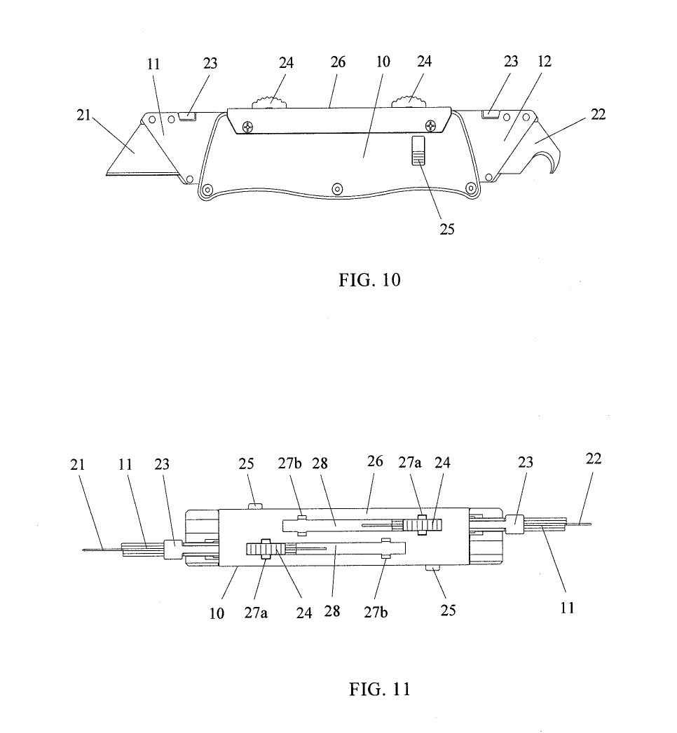

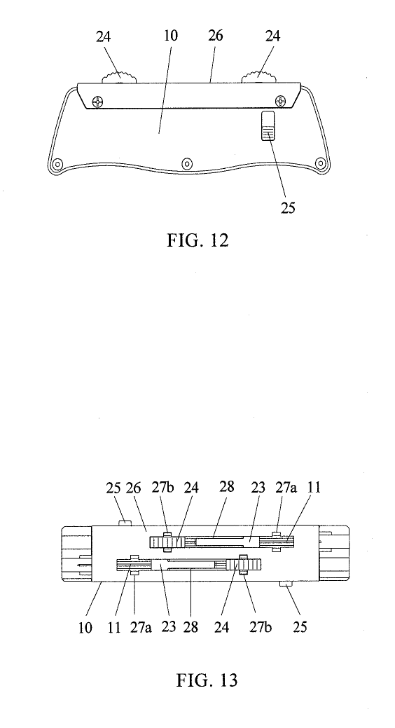

FIG. 10 and FIG. 11 show another embodiment of the present invention. In this embodiment, the first mounting bracket 11 and the second mounting bracket 12 are arranged in the utility knife body 10 with the ability to extend and retract through an extendable mechanism. The mounting brackets 11, 12 are in the first work position when in unfolded state; and the mounting brackets are in the second work position when in folded state.

The utility knife body 10 has a top surface 26 which is arranged with two elongated grooves 28 extending longitudinally along the utility knife body 10. A pushing block 24 is arranged on the mounting brackets 11, 12, which protrudes out of the top surface 26 of the knife 10, convenient for holding down by hands to move longitudinally along the elongated groove 28, so as to drive the mounting brackets 11, 12 to move longitudinally to extend out of or retract into the utility knife body 10. For better result of gripping and reliability, the part of the pushing block 24 protruding out of the top surface 26 has a ridged periphery.

Each elongated groove 28 has two positioning recesses 27a; 27b arranged longitudinally thereon, where the positioning recess 27a locates adjacent to the end part of the utility knife body 10, while the positioning recess 27b locates distantly from the end part of the knife 10. Each pushing block 24 has a positioning block arranged thereon to engage respectively with the positioning recesses 27a and 27b. When the mounting brackets 11, 12 are in the second work position where the said supports are retracted into the utility knife body 10, the positioning block coordinates with the positioning recess 27b, so as to stop the movement of the pushing block 24 while retaining the mounting brackets 11, 12 in the second work position. When using the blades 21 or 22, firstly use a finger (e.g. a thumb) to push down and move the pushing block 24 to detach its positioning block from the engagement with the positioning recess 27b, and then to push forward the pushing block 24 so as to drive the relative mounting brackets 11, 12 to extend out of the utility knife body 10. When the mounting brackets 11, 12 reach the first work position, release the force applied on the pushing block 24 to make the positioning block on the pushing block 24 to enter into the positioning recess 27a and to engage with said recess under the effect of a reset spring, so that the mounting brackets 11, 12 are not allowed to retract freely back into the utility knife body 10.

In order to prevent the mounting brackets 11, 12 from being unconsciously pushed out of the utility knife body 10 by operators or others, and from sliding out of the utility knife body 10 under unknown impact by other objects while inside a tool bag or pocket, the utility knife body 10 has on its both sides arranged with a lock block 25. Only when users toggle the lock block 25 to switch it to unlocked position, the mounting brackets 11, 12 can be pushed out of the utility knife body 10, and when the mounting brackets 11, 12 are pushed out of the utility knife body 10, the lock block 25 will automatically switch back to lock position, which is realizable by setting a reset spring. When users pull the mounting brackets 11, 12 back into the utility knife body 10 after using, the lock block 25 can automatically lock the mounting brackets 11, 12 in the lock position under the effect of the reset spring, so as to prevent any induced security hazard due to negligence of users to toggle the lock block to lock position. Lock block 25 switches between the unlocked position and lock position under toggling of users. When the lock block 25 is moved to the lock position, the mounting brackets 11, 12 are respectively locked inside the utility knife body 10; while the lock block 25 is moved to the unlocked position, so that the lock to the mounting brackets 11, 12 are respectively released, the mounting brackets 11, 12 extend out of the utility knife body 10 by moving the pushing block 24.

In this embodiment, the top part of the mounting brackets 11, 12 are also arranged with lock members 23, which are used to lock the blades 21, 22 respectively to the mounting brackets 11, 12. The blade lock member 23 is a elongated resilient strip member, one end of which adjacent to the utility knife body 10 is fixed on the mounting brackets 11, 12, and the other end is in a free state. In work positions, the blade lock member 23, under the effect of the resilient force of its own, the free end pressures on the blades 21, 22 and keeps the blades 21, 22 on the mounting brackets 11, 12. When the blades 21, 22 need to be detached for replacement, first the mounting brackets 11, 12 are extended out of the utility knife body 10, and then use fingers to lift up the free end of the blade lock member 23, releasing its pressure on the blades 21, 22, so that the blades 21, 22 can be easily and swiftly detached from the mounting brackets 11, 12.

The above gives details of the preferable embodiments of the invention. It should be understood that with the general technique of this field, no inventive work is necessary as to make multiple amendments and changes according to conception of this invention. Therefore, all the technical schemes gained from logical analysis, deductions or limited experimentation based on the present invention by technicians in this field, should be considered within the protection range asserted in the Claims.

1. A utility knife, comprising at least a utility knife body which has a first end part and a second end part, characterized in that the first end part is arranged with a first mounting bracket for mounting a first blade, and the second end part is arranged with a second mounting bracket for mounting a second blade.

2. The utility knife as claimed in claim 1, wherein at least one of the first blade and second blade is mountable in a detachable manner on either of the first mounting bracket and the second mounting bracket respectively.

3. The utility knife as claimed in claim 1, wherein at least one of the blades is a trapezoidal blade.

4. The utility knife as claimed in claim 1, wherein at least one of the blades is a horn-shaped blade.

5. The utility knife as claimed in claim 1, wherein the thickness of the blades is between 0.3 mm to 1.0 mm.

6. The utility knife as claimed in claim 2, wherein the first blade and the second blade are exactly identical blades.

7. The utility knife as claimed in claim 2, wherein the first blade and the second blade are blades of different cutting functionalities.

8. The utility knife as claimed in claim 2, wherein the first blade and the second blade are mountable on the first mounting bracket and the second mounting bracket respectively.

9. The utility knife as claimed in claim 1, wherein at least one of the first mounting bracket and the second mounting bracket has a first work position exposed outside of the utility knife body, and a second work position contained inside the utility knife body.

10. The utility knife as claimed in claim 1, wherein at least one of the mounting brackets connects pivotally to the utility knife body by pivot; at least one of the mounting brackets is in the first work position when in unfolded state and in the seconded work position when in folded state.

11. The utility knife as claimed in claim 1, wherein at least one of the mounting brackets is extendable and retractable relative to the utility knife body through an extendable mechanism; at least one of the mounting brackets locates in the first work position when in unfolded state and in the second work position when in folded state.

12. The utility knife as claimed in claim 11, wherein a lock block is arranged on the utility knife body, used for locking the mounting brackets inside the utility knife body when the mounting brackets locate in the second work position.

13. The utility knife as claimed in claim 11, wherein at least one of the mounting brackets is arranged with a pushing block which is movable along a longitudinal elongated groove arranged on the utility knife body under the push of external force, thus moving the mounting bracket longitudinally along the utility knife body; the part of the pushing block protruding out of the top surface has a ridged periphery.

14. The utility knife as claimed in claim 13, wherein the elongated groove has two positioning recesses thereon, and respectively locating adjacent to and distantly from at least one of the end parts, the pushing block is arranged with a positioning block, the positioning block engages with the positioning recesses to stop the movement of the pushing block, so as to stop the movement of at least one of the mounting brackets.

15. The utility knife as claimed in claim 11, wherein at least one of the mounting brackets is arranged with a lock member, used for detachably retaining the blades on the mounting brackets.

16. The utility knife as claimed in claim 15, wherein the blade lock member is an elongated resilient sheet, one end of which is fixed on the mounting brackets, and its free end, under the effect of the resilient force, pressures the blades on the mounting brackets to make them non-movable.

17. The utility knife as claimed in claim 10, wherein a retaining mechanism, which is used for releasable retaining of any of the mounting brackets in the first work position, is arranged on the utility knife body, the retaining mechanism comprising a retaining member arranged on the utility knife body and a retaining part, engaging with the retaining member, arranged on any of the mounting brackets.
